(19) United States
(12) Patent Application Publication
(10) Pub. No.: US 2025/0117811 A1
(43) Pub. Date: Apr. 10, 2025

(54) AUTHENTICATION KIT

(71) Applicant: HANGING WITH THE TEAM, LLC, Pittsburgh, PA (US)

(72) Inventor: Timothy Carey, Pittsburgh, PA (US)

(73) Assignee: HANGING WITH THE TEAM, LLC, Pittsburgh, PA (US)

(21) Appl. No.: 18/906,998

(22) Filed: Oct. 4, 2024

Related U.S. Application Data
(60) Provisional application No. 63/587,819, filed on Oct. 4, 2023.

(51) Int. Cl. G06Q 30/018; G06K 19/04

(52) U.S. Cl. CPC G06Q 30/0185; G06K 19/045

(57) ABSTRACT

Embodiments relate to a system, method and kit for authenticating an object. The kit includes a tag which may be embroidered, printed, cloth, or other non-removable object which contains a unique serialized number, the number directing a consumer to a team's database for authentication. The kit may allow for the object to be hung in a team's locker room or an individual player's locker during, for example, gameday. The kit may also include unique hang tags, hanger tags and/or hangers, and may further include a unique downloadable certificate of authority. The kit allows for an item to be present during team gatherings in order to absorb the positive energy and powerful mojo from the team to pass along to users on gameday. An exemplary system includes a processor including an authentication module and an interfacing module, a database, and a memory for authenticating an object is also provided.

### CROSS-REFERENCE TO RELATED APPLICATIONS

This patent application claims the benefit of and priority to co-pending U.S. Provisional Patent Application No. 63/587,819, filed on Oct. 4, 2203, the entire contents of which is incorporate herein by reference.

### FIELD OF THE INVENTION

Embodiments relate to an authentication kit comprising an embroidered or printed cloth tag including a uniquely serialized number directing a consumer to a team's database for object authentication.

### BACKGROUND OF THE INVENTION

Collective memorabilia, specifically sports memorabilia, is often more valuable when it is autographed or authenticated. Sports memorabilia may include equipment, trophies, sports cards, autographs, photographs, jerseys, hats, and helmets, among many others. Specifically, game used jerseys became one of the first “hot ticket” items for sports memorabilia collectors. Collection of sports memorabilia has become a multi-billion-dollar industry, with certain items being valued at millions of dollars.

The value of an item is generally relative to the profile of the original owners/wearers/users, provenance of the object, scarcity of the item, sentimental value if personalized, etc. Collectors who are interested in purchasing these objects typically look for any type of certificate of authenticity. Authentication may be necessary to prove validity of an object which may have been present or used during a certain event, which may be historic. Authentication can be difficult as signatures or the provenance surrounding an object can easily be faked.

Typically, collectors and auction houses use third party authenticators, such as, for example, professional sports authenticators, to determine validity of objects. Several other companies have developed systems to prove the authenticity of game-used or other autographed memorabilia, and collectors typically seek out those who offer a lifetime authenticity guarantee. These techniques tend to be costly and inefficient. In some instances, the safeguards of these conventional methods can be circumvented, thereby rendering the authentication ineffective.

Therefore, there exists a need for a reliable, inexpensive and trustworthy authentication system for objects such as sports memorabilia. Sports fans are known for their passion, and the feelings and excitedness with the team is an integral part of the game. Therefore, fans have a need to feel as much a part of the team as possible. Thus, there is also a need to couple or interject a sense of connectedness to a team with which the object is associated.

The present disclosure is directed toward overcoming one or more of the above-mentioned problems, though not necessarily limited to embodiments that do.

### SUMMARY OF THE INVENTION

Embodiments of the present disclosure relate to a kit for authenticating an object. In an exemplary embodiment, the kit comprises an embroidered or printed cloth tag, wherein the tag is non-removably attached to the object and wherein the tag contains a unique serialized number, the number directing a consumer to a database which authenticates the object and can provide a certificate of authenticity.

The kit also is used to create a special feeling of inclusiveness with the team. For instance, the kit may be used to imbibe the user with a sense of power as though they are in the locker room with the team. In this regard, the kit provides users with the opportunity to feel as though they are in fact with the team by authenticating items that were present in team areas, such as, for example, in the locker room or a player's locker during game day.

In an exemplary embodiment, a method for authenticating an object is provided, wherein the object is labeled with a non-removable tag including a unique serialized number, and the number is stored in a database (which may be accessible by online users) for reference and to provide a purchaser with a certificate of authenticity. The tag (e.g., a heat seal patch) can be embroidered with, or otherwise include, the unique serialized number. In some embodiments, the tag can contain a unique radio frequency identification device (RFID) which may be scanned by a complementary device.

In some embodiments, the object is sports memorabilia, such as a jersey, uniform, hat, equipment, etc. It is contemplated for the object to be something that is hung or placed within a sports team locker room or an individual player's locker during game day. The kit may include a hanger upon which a jersey was hung in the player's locker during, for example, game day. In some embodiments, the kit can also include a hang tag and/or hanger tag that includes information about the player, team, locker, date, time, etc. of the object. As will be explained herein, embodiments of the kit can include a means to obtain a unique downloadable certificate of authenticity. This certificate can authenticate that the object an original, a true version, has been autographed by a certain player, had in fact appeared in the player's locker room at a certain date/time, etc.

While the present disclosure may discuss and illustrate objects pertaining to sports, it is understood that the objects are not limited thereto. For instance, the object can be or include any item.

An exemplary embodiment relates to a system for authenticating an object and/or a characteristic of the object. The system includes a processor including an authentication module and an interfacing module. The system includes a database. The system includes a memory operatively associated with the processor, the memory having instructions stored thereon that when executed by the processor causes the processor to carry out one or more of the functions disclosed herein. The instructions cause the authentication module to generate an object token, the object token including an identifier and associated information related to an object or a characteristic of the object. The instructions cause the authentication module to transmit the object token to the database for storage in the database. The instructions cause the interfacing module to generate a graphical user interface (GUI) for display at a user-computer, the GUI configured to allow a user to enter the identifier. The instructions cause the interfacing module to transmit the identifier to the authentication module, wherein the authentication module is configured to retrieve the object token associated with the identifier from the database and cause the interfacing module to display the associated information related to the object or the characteristic of the object.

In some embodiments, the object is an object set that includes one or more objects. The object token pertains to all objects within the object set. In the alternative, each object in the object set can have an individual object token.

In some embodiments, the interfacing module generates a certificate of authenticity authenticating the object and/or the characteristic of the object.

In some embodiments, the certificate of authenticity is in digital form configured to be stored in memory of the user-computer. In addition, or in the alternative, the certificate of authenticity is a prompt to facilitate printing the certificate of authenticity via the user-computer.

In some embodiments, the object token is a nonfungible digital identifier, a unique barcode, a unique serial number, a unique hologram, an encrypted data structure, and/or an encoded data structure.

In some embodiments, the object is an item. The characteristic of the object includes a type of the object, a sports team associated with the object, a sports player associated with the object, a locker associated with the object, an event associated with the object, and/or a place, date, and time associated with the object.

In some embodiments, the object includes one or more of sports clothing, sports memorabilia, sports equipment, or an artifact used with or attached to the object.

In some embodiments, the artifact used with or attached to the object includes a tag, a hangtag, and/or a hanger.

An exemplary embodiment relates to an authentication kit. The authentication kit includes an identifier for the object to be authenticated, the identifier being associated with an object token for the object. The object token includes the identifier and associated information related to the object or a characteristic of the object. The object token is stored in a database. The identifier is configured to be entered into a user-computer via a graphical user interface (GUI), wherein the object token associated with the identifier is retrieved from the database and the associated information related to the object or the characteristic of the object is displayed via the GUI.

In some embodiments, the object is an object set that includes one or more objects. The object token pertains to all objects within the object set. In the alternative, each object in the object set has an individual object token.

In some embodiments, the authentication kit includes a certificate of authenticity authenticating the object and/or the characteristic of the object.

In some embodiments, the certificate of authenticity is in digital form configured to be stored in memory of the user-computer, the certificate of authenticity is a prompt to facilitate printing the certificate of authenticity via the user-computer, and/or the certificate of authenticity is hardcopy included with the authentication kit.

In some embodiments, the object token is a nonfungible digital identifier, a unique barcode, a unique serial number, a unique hologram, an encrypted data structure, and/or an encoded data structure.

In some embodiments, the object is an item. The characteristic of the object includes a type of the object, a sports team associated with the object, a sports player associated with the object, a locker associated with the object, an event associated with the object, and/or a place, date, and time associated with the object.

In some embodiments, the object includes one or more of sports clothing, sports memorabilia, sports equipment, or an artifact used with or attached to the object.

In some embodiments, the artifact used with or attached to the object includes a tag, a hangtag, and/or a hanger.

An exemplary embodiment relates to a method for authenticating an object and/or a characteristic of the object. The method involves generating an object token, the object token including an identifier and associated information related to an object or a characteristic of the object. The method involves storing the object token in a database. The method involves generating a graphical user interface (GUI) for display at a user-computer, the GUI configured to allow a user to enter the identifier. The method involves using user-entered identifier to retrieve the object token associated with the identifier from the database to display the associated information related to the object or the characteristic of the object via the GUI.

In some embodiments, the method involves providing a kit that includes the object.

In some embodiments, the object is an object set that includes one or more objects. The object token pertains to all objects within the object set. In the alternative, each object in the object set has an individual object token.

In some embodiments, the object includes one or more of sports clothing, sports memorabilia, sports equipment, or an artifact used with or attached to the object.

In some embodiments, the tag is embroidered with the unique serialized number.

In some embodiments, the tag contains a unique radio frequency identification device (RFID) which may be scanned by a complimentary device.

In some embodiments, the database is accessible online to users.

In some embodiments, the object is hung in a sports team locker room or an individual player's locker during, for example, game day.

In some embodiments, the kit additionally includes a unique downloadable certificate of authenticity.

In some embodiments, kit additionally includes unique hangtags and/or hangers.

Additional features, aspects, objects, advantages, and possible applications of the present disclosure will become apparent from a study of the exemplary embodiments and examples described below, in combination with the Figures and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1A shows an exemplary system diagram, and FIG. 1B shows an exemplary graphical user interface.

FIG. 2 shows an exemplary tag artifact with an identifier printed thereon.

FIG. 3 shows an exemplary hanger tag artifact.

FIG. 4 shows exemplary components that may be included with an embodiment of the authentication kit applied to an authenticated object.

FIG. 5 shows one side of an exemplary hang tag artifact.

FIG. 6 shows an opposite side of an exemplary hangtag artifact.

FIG. 7 shows an exemplary hanger artifact.

FIG. 8 shows an exemplary authentication kit with a certificate of authenticity.

FIG. 9 shows an exemplary certificate of authenticity.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of various aspects of the present invention. The scope of the present invention is not limited by this description.

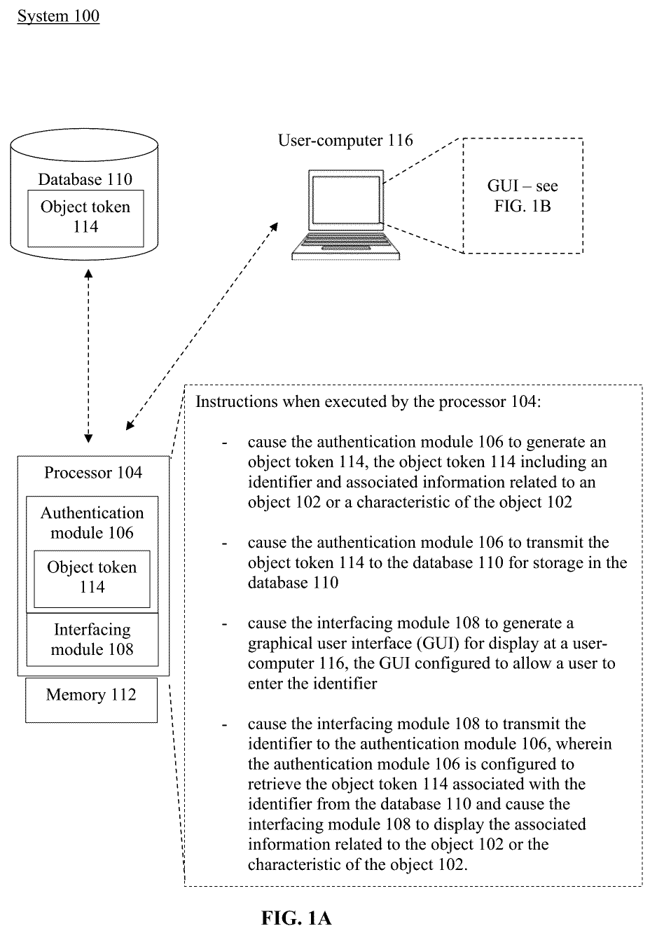

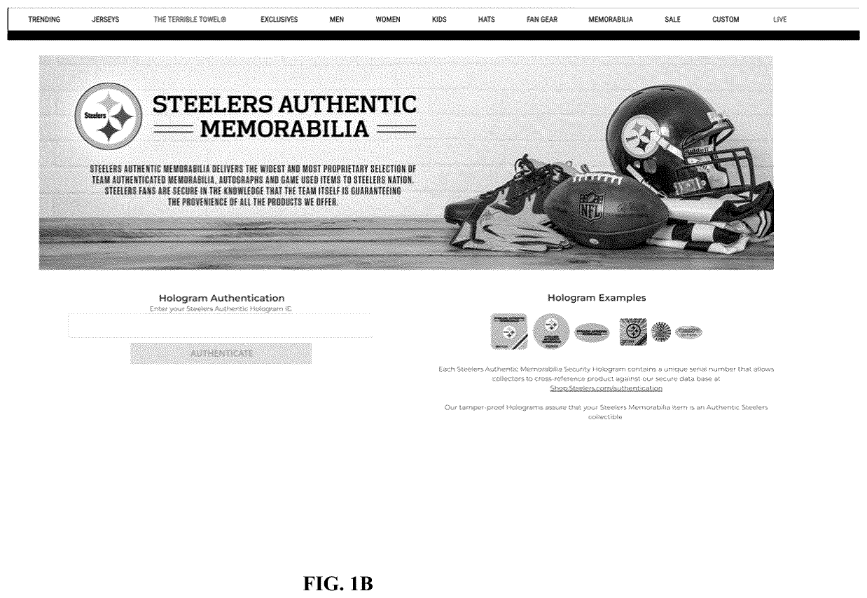

Referring to FIG. 1, embodiments can relate to a system 100 for authenticating an object 102 and/or a characteristic of the object 102. The system 100 can include one or more processors 104. The processor(s) 104 can include one or more processing modules. For instance, the processor 104 can include an authentication module 106, an interfacing module 108, etc. The system 100 can include one or more databases 110. The system 100 can include one or more memories 112. The memory(ies) 112 can be operatively associated with the processor 104. The memory 112 can have instructions stored thereon that when executed by the processor 104 can cause the processor 104 to carry out one or more of the functions disclosed herein.

The processor 104 can be any of the processors 104 disclosed herein. The processor 104 can be part of or in communication with a machine (logic, one or more components, circuits (e.g., modules), or mechanisms). The processor 104 can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. Use of processors 104 herein can include any one or combination of a Graphics Processing Unit (GPU), a Field Programmable Gate Array (FPGA), a Central Processing Unit (CPU), etc. The processor 104 can include one or more processing modules. A processing module can be a software or firmware operating module configured to implement any of the method steps disclosed herein. The processing module can be embodied as software and stored in memory 112, the memory 112 being operatively associated with the processor 104. A processing module can be embodied as a web application, a desktop application, a console application, etc.

The processor 104 can include or be associated with a computer or machine readable medium. The computer or machine readable medium can include memory 112. The computer or machine readable medium can be configured to store one or more instructions thereon. The instructions can be in the form of algorithms, program logic, a model, etc. that cause the processor 104 to perform any of the functions described herein.

Any of the memory 112 discussed herein can be computer readable memory configured to store data. The memory 112 can include a volatile or non-volatile, transitory or non-transitory memory, and be embodied as an in-memory, an active memory, a cloud memory, etc. Embodiments of the memory 112 can include a processor module and other circuitry to allow for the transfer of data to and from the memory 112, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

The processor 104 can be in communication with other processors of other devices (e.g., a computer device, a desktop computer, a laptop computer, a computer system, etc.). Any of those other devices can include any of the exemplary processors disclosed herein. Any of the processors 104 can have transceivers or other communication devices/circuitry to facilitate transmission and reception of wireless signals. Any of the processors 104 can include an Application Programming Interface (API) as a software intermediary that allows two applications to talk to each other. Use of an API can allow software of the processor 104 of the system 100 to communicate with software of the processor 104 of the other device(s), if the processor 104 of the system is not the same processor of the device.

Any data transmission between the processor 104 and memory 112, between the processor 104 and the database 110, and between the processor 104 and processors 104 of other devices, etc. can be via a pull operation (e.g., the processor 104 can pull the data) or a push operation (e.g., the data can be pushed to the processor 104). The processor 104 can receive the data in steaming format, or store it in memory 112 before being processed. In addition, embodiments of the algorithm, model, etc. disclosed herein can be developed as an application software (an “App”) to be implemented on a processor 104 of a device. The App can be sent via a steaming format, or the App can be sent and stored on a memory 112 associated with or accessed by the device.

As noted herein, the processor 104 can be configured to be a component of, used in combination with, or in communication with another device/system—e.g., this can include the processor 104 being part of the device/system, the device/system being part of the processor 104, the processor 104 in communication with the device/system, etc. “Being part of” can include being on a same substrate or integrated circuit. For instance, the processor 104 can be a component of, used in combination with, or in communication with a database management system, a merchant transaction system, etc. The processor 104 can use the model or algorithm or provide the model or algorithm to the device/system to assist with or augment the performance of these devices/systems.

While exemplary embodiments may describe and/or illustrate one processor 104 and one memory 112, it is understood that the system 100 can include any number of processors 104 and memories 112.

The instructions can cause the authentication module 106 to generate one or more object tokens 114. The object token 114 can include an identifier and associated information related to an object or a characteristic of the object 102. Any of the object tokens 114 can be a nonfungible digital identifier (e.g., a unique digital identifier recorded on a blockchain), a unique barcode, a unique serial number, a unique hologram, an encrypted data structure, an encoded data structure, etc. One object token 114 can be the same type or a different type of token as another object token 114.

It is contemplated for the system 100 and methods disclosed herein to be used to authenticate the object 102 or a characteristic associated with the object 102. As will be explained herein, the object token 114 is used in this regard. For instance, the object token 114 can serve as a unique identifier for a particular object 102 and also a certification of the characteristics of that object 102. While the identifier of the object token 114 is generated by the authentication module 106, the associated information related to the object 102 or a characteristic of the object 102 is entered via an authorized administrator of the system 100. The authorized administrator can be or include an independent agent that can attest to the authenticity of the object 102 and/or the characteristics of the object 102.

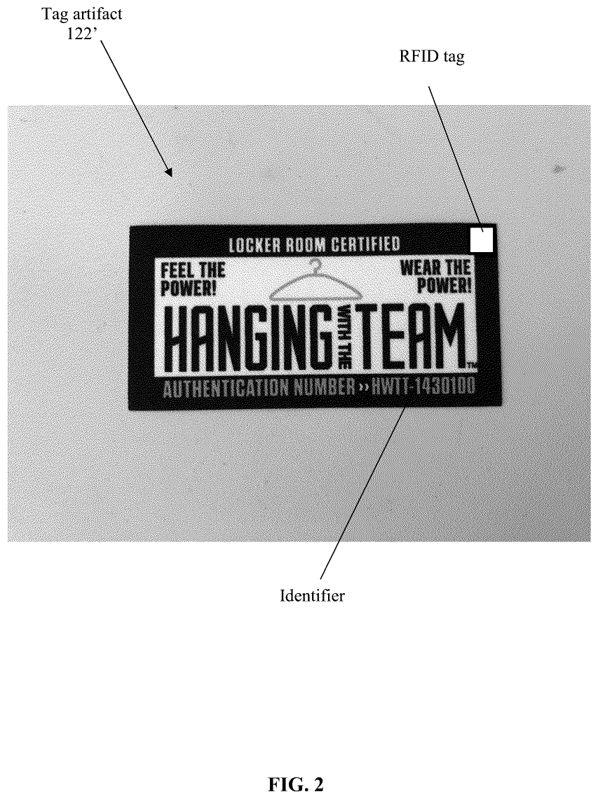

Referring to FIGS. 2-7, the object 102 can be object set that includes one or more objects 102. For instance, an object set can be a jersey, a hat, glove, ball, etc., that had been worn or used by a particular player. The system 100 can be configured to generate an object token 114 for the object set (e.g., the object token 114 can pertain to all objects within the object set), each object 102 in the object set can have an individual object token 114 associated therewith, one object 102 in the object set can have an individual object token 114 while more than on objects 102 in the object set can have another object token 114, etc.

The object 102 can be an item. For instance, the object 102 can be or include one or more of sports clothing, sports memorabilia, sports equipment, and an artifact 122 (tag, hang tag, hanger tag, hanger) used with or attached to the object 102, etc. The artifact 122 used with or attached to the object 102 can include a tag 122′, a hanger tag 122″, a hang tag 122′″, a hanger 122″″, etc. The tag 122′ can be a label, ticket, mark, etc. that is attached to the object 102, placed next to the object 102, etc. The tag 122′ can include information (e.g., information related to object 102 or a characteristic of the object 102). In one embodiment, the tag 122′ is a heat seal patch applied to the object 102. The hanger 122″″ can be the item that was used to hang a jersey (e.g., the object) in the locker. The hanger tag 122″ can be a label, placard, sign, etc. that is suspended from the hanger 122″″, and can include information (e.g., information related to object 102 or a characteristic of the object 102). The hang tag 122′″ is applied to the object 102 and tells a story or provides information the about the object 102, the player and/or the team.

The characteristic of the object 102 can include a type of the object 102 (e.g., it is a ball, a shirt, a hat, a helmet, etc.), a sports team associated with the object 102 (the object 102 was used for or by Team X, was used when Team X and Team Y played each other, etc.), a sports player associated with the object 102 (the object 102 was used by Player X), a locker associated with the object 102 (e.g., object was placed in Player X's locker during a game day), an event associated with the object 102 (the object 102 was the football caught by Player X when Player X scored a touchdown in a certain game, e.g., Super Bowl), a place, date, and time associated with the object 102 (e.g., the object is a baseball that was used in Stadium X, on Date X, and Time X), etc.

Referring back to FIG. 1A, the instructions can cause the authentication module 106 to transmit the object token 114 to the database 110 for storage in the database 110. The database 110 can store any number of object tokens 114 for any number of objects 102. The database 110 can be configured to store the object tokens 114 as data structure within a data table, for example. The data structures can include information about the object 102, characteristics about the object 102, owners of the object 102, value of the object 102, location of the object 102, etc.

The instructions cause the interfacing module 108 to generate a graphical user interface (GUI) for display at a user-computer 116. The GUI can be configured to allow a user to enter the identifier. For instance, when a user acquires the object 102 (e.g., purchases the object 102), the user can be given the identifier for that object. The identifier can be a unique barcode, a unique serial number, a unique hologram, etc. In some embodiments, the identifier can be a radio frequency identification signal or signature, wherein the object 102 and/or an artifact 122 can be equipped with a radio frequency identification (RFID) tag. A RFID scanner device can be used to obtain the RFID signal or signature. The RFID scanner can include any of the processors 104 disclosed herein and be in communication with the processor 104 of the system 100 or in communication with the database 110. The RFID scanner can also be in communication with the user-computer 116.

When a user enters the identifier via the GUI, the interfacing module 108 can allow the user to register themself as the owner of the object 102. If/when the object 102 is subsequently transferred to another, the other person can do the same and register as the current owner. The database 110 can store this information so that the system 100 record and track chain of title of the object 102.

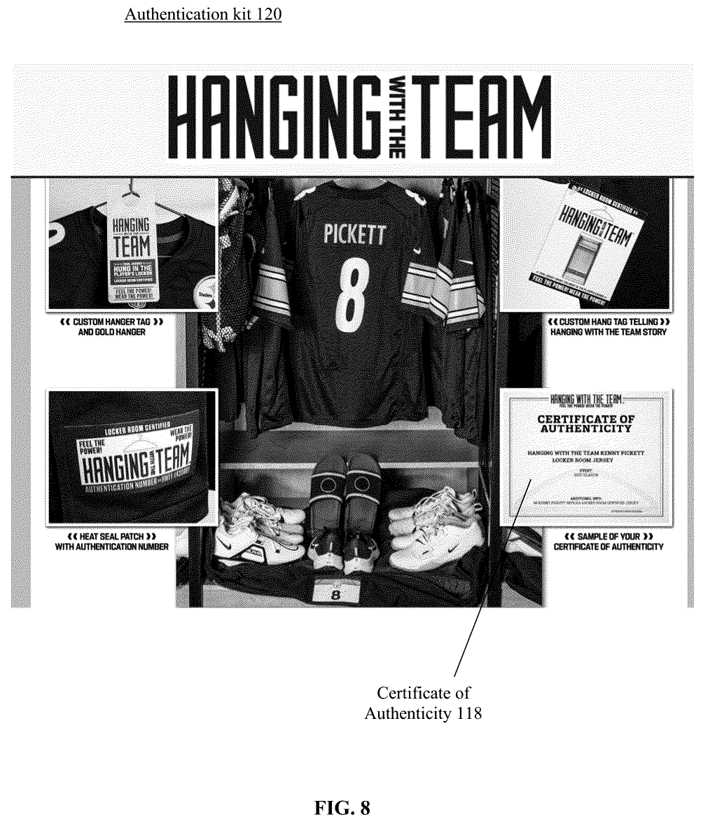

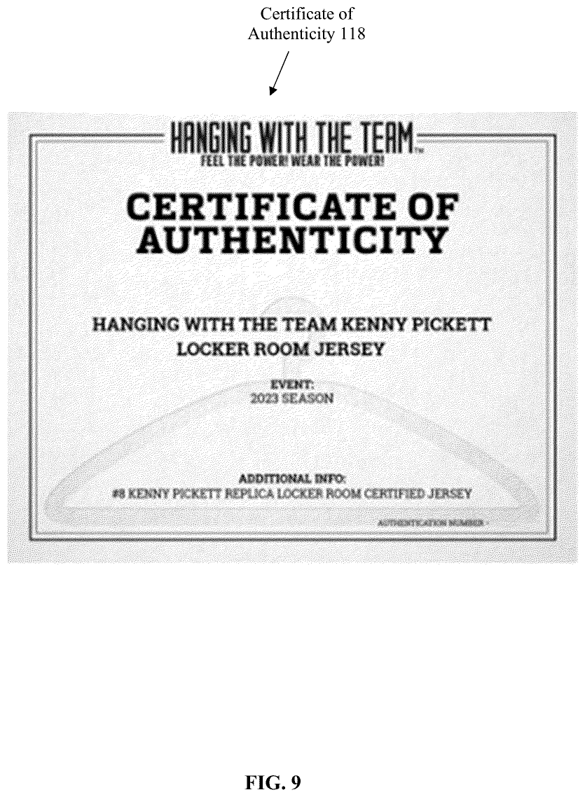

Upon entering the identifier via the GUI (see FIG. 1B), the instructions can cause the interfacing module 108 to transmit the identifier to the authentication module 106. The authentication module 106 can be configured to retrieve the object token 114 associated with the identifier from the database 110. The instructions can cause the interfacing module 108 to display the associated information related to the object 102 or the characteristic of the object 102. In addition, or in the alternative, the instructions can cause interfacing module 108 to generate one or more certificates of authenticity 118 (see FIGS. 8-9). The certificate of authenticity 118 can serve to authenticate the object 102 and/or the characteristic(s) of the object 102. The certificate of authenticity 118 can be in digital form configured to be stored in memory 112 of the user-computer, the certificate of authenticity 118 can be a prompt to facilitate printing the certificate of authenticity 118 via the user-computer, etc. Any one certificate of authenticity 118 can be the same type of different type from any other certificate of authenticity 118.

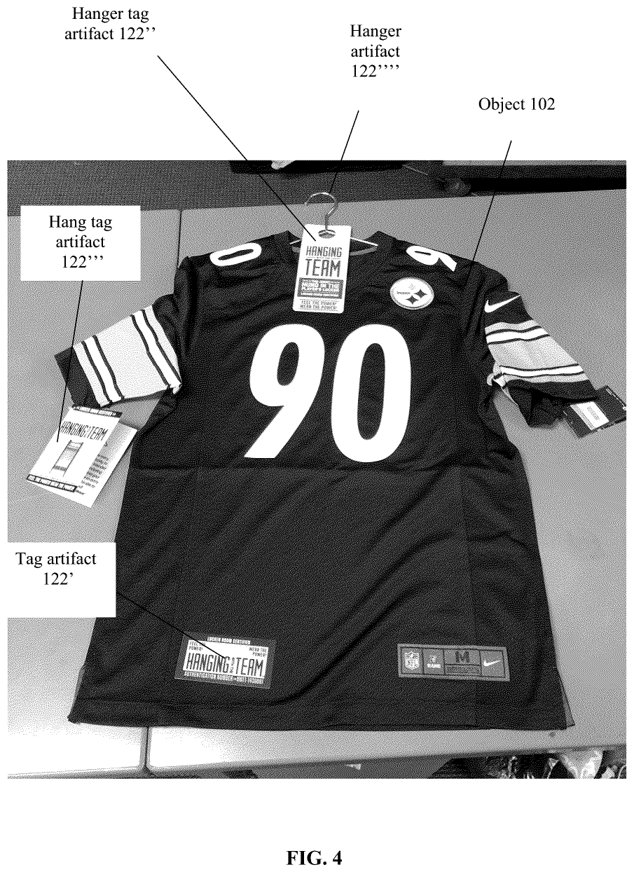

Referring to FIGS. 4 and 8, as noted herein, it is contemplated for the objects 102 to be sold to users. Some embodiments can involve selling the object 102 authenticated by the kit, or merely selling the authentication kit(s) which may allow users to subsequently authenticate the object 102 for sale. The authentication kit 120 can include an identifier for the object 102. The identifier can be associated with an object token 114 for the object 102. For instance, the object token 114 can include the identifier and associated information related to the object 102 or a characteristic of the object 102. The object token 114 can be stored in a database 110. The identifier can be configured to be entered into a user-computer 116 via a graphical user interface (GUI). Upon entering the identifier, the object token 114 associated with the identifier can be retrieved from the database 110 and the associated information related to the object 102 or the characteristic of the object 102 can be displayed via the GUI.

With the authentication kit 120, the object 102 can be an object set that includes one or more objects. The object token 114 can pertain to all objects within the object set, each object 102 in the object set can have an individual object token 114, etc.

The authentication kit 120 can include a certificate of authenticity 118 authenticating the object 102 and/or the characteristic of the object 102. The certificate of authenticity 118 can be in digital form configured to be stored in memory 112 of the user-computer 116, the certificate of authenticity 118 can be a prompt to facilitate printing the certificate of authenticity 118 via the user-computer 116, the certificate of authenticity 118 can be a hardcopy included with the authentication kit 120, etc.

As can be appreciate, embodiments can relate to a method for authenticating an object 102 and/or a characteristic of the object 102. The method can involve generating an object token 114. The object token 114 can include an identifier and associated information related to the object 102 or a characteristic of the object 102. The method can involve storing the object token 114 in a database 110. The method can involve generating a graphical user interface (GUI) for display at a user-computer 116. The GUI can be configured to allow a user to enter the identifier. The method can involve using user-entered identifier to retrieve the object token 114 associated with the identifier from the database 110. The method can involve displaying the associated information related to the object 102 or the characteristic of the object 102 via the GUI.

### EXAMPLES

The following disclosure discusses exemplary authentication kits 120 and system 100 implementations for the same.

Embodiments relate to an authentication kit 120. The kit 120 may be used to authenticate an object 102, specifically sports memorabilia. The object 102 may be an item of clothing, or a piece of sports equipment, among others.

Specifically, the kit 120 is used with items that may be in a sports team locker room or a player's locker to provide the user with a feeling of excitedness by imbibing them with the feeling of hanging out with the sports team in the locker room during, for example, game day. The item may “absorb” the mojo of the team in the locker room during game day. As such, the value of the item will increase due to its uniqueness of being with the team and/or player during game day. More specifically, the user may be given a powerful mojo to awaken and permeate themselves and those around them with a special power when wearing or in the presence of the item 102.

Embodiments further relate to a method for authenticating an object 102, specifically a piece of sports memorabilia.

The kit 120 comprises a plurality of objects 102 to authenticate the object 102. The kit 120 may include a tag 122′ having a unique serialized number, a hanger tag 122″ including information (e.g., information related to object 102 or a characteristic of the object 102), a hang tag 122′″ which tells a story or provides information the about the object 102, the player and/or the team, and/or a hanger 122″″. The tag 122′ may consist of cloth, paper, or other non-removable material. Alternatively, the tag 122′ may be a unique RFID tag or other electronic method of marking, which may be scanned by a complementary device. In one embodiment, it is contemplated for the hanger 122″″ to be gold in color. But any color may be used, including those associated with the player and/or team.

As may be seen in FIG. 2, the cloth tag 122′ may have printed or embroidered upon it a unique serialized number (Identifier) which directs the user to a database 110. The database 110 may be managed by a sports team or other third party which creates a record for said unique serialized number so that the item 102 can be authenticated. For instance, in one exemplary embodiment, the item 102 may be a jersey that hung in a team locker room or a player's locker during game day. The cloth tag 122′ is affixed to the jersey 102. The purchaser can access the database 110 and input the unique serialized number (Identifier). The purchaser will be provided a downloadable certificate of authenticity 118 to indicate information relating to the item 102, for example, that the jersey 102 hung in the team's locker room or a player's locker during game day (identifying the game and date). Thus, the purchaser is assured that the jersey 102 was present with the team or player and absorbed the good feelings, or “mojo” that is given off in the locker room during game day. Such an authentication adds value to the jersey 102. Of course, the above example is exemplary only, and the authentication kit 120 may be used to authenticate that any item 102 has been in the presence of the team or player for any set period of time. The jersey 102 or other item 102 also could have worn or used by the player or coach during game day.

The unique downloadable certificate of authenticity 118 may be downloaded and/or printed by the purchaser for their own purposes.

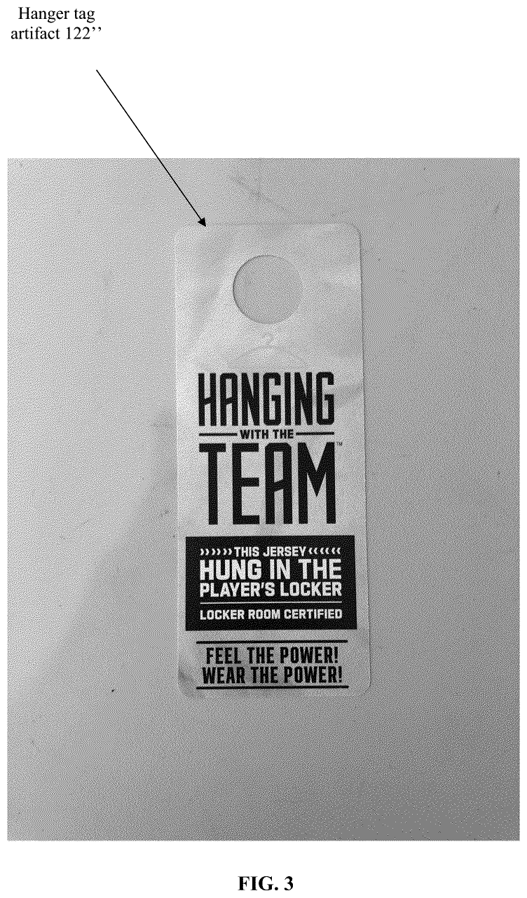

The kit 120 may also include, as listed above, unique hanger tags 122″, hang tags 122′″ and/or hangers 122″″. As seen in FIG. 3, an exemplary hanger tag 122″ will tell the user that the item 102 hung in a player's locker during game day. The player or user may be identified on the hanger tag 122″. While not shown in FIG. 3, the hanger tag 122″ may also be printed with the same unique serialized number that is used on the cloth tag 122′ for consistency purposes.

As seen in FIG. 4, the entire kit 120 may include the cloth tag 122′ with a unique serialized number, a hanger tag 122″, a hang tag 122′″, and/or a hanger 122″″ 150, if necessary for the item 102 type. This can provide an opportunity to authenticate and label a piece of sports memorabilia, such as, for example, a jersey 102. The jersey 102 and/or item 102 for authentication may be placed in the locker room, player's locker or other area where the sports team assembles. The jersey 102 or item 102 for authentication remains in the area with the team and/or player, to absorb the energies, mojo and power that emanates from the players. The cloth tag 122′ is attached to the jersey 102 or item 102 for authentication, either before or after being in the area with the team and/or worn or used by the user. The cloth tag 122′ assures the purchaser that the jersey 102 or item 102 absorbed the power, mojo, excitedness and energy from the team and/or player during gameday.

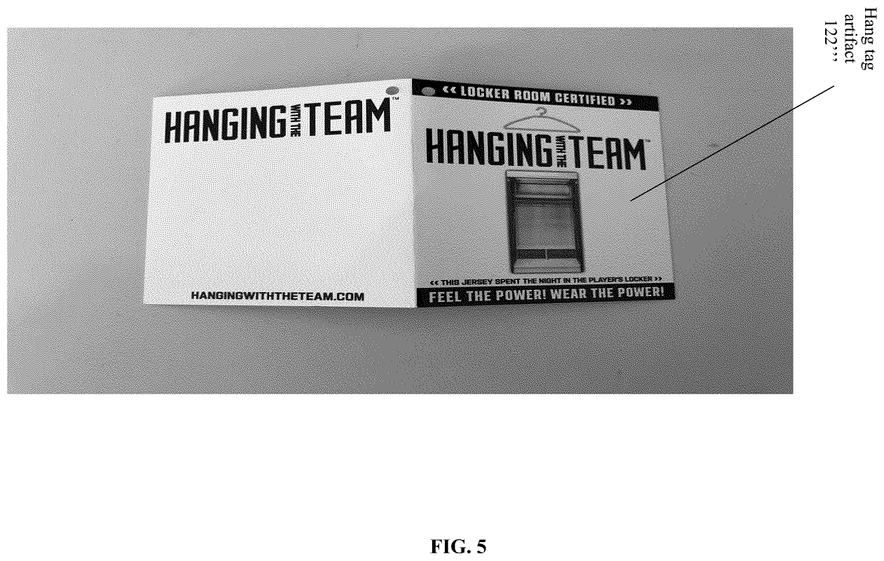

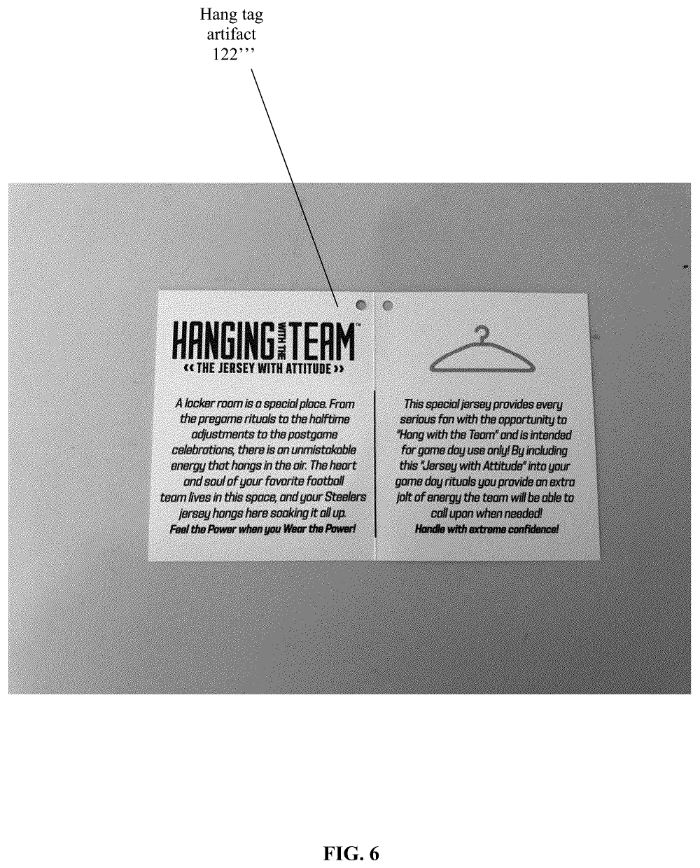

As seen in FIGS. 5-6, the hang tag 122′″ affixed to the item 102 may describe the innate abilities of the item, which were garnered by the nature of the item's 102 presence with the team and/or player.

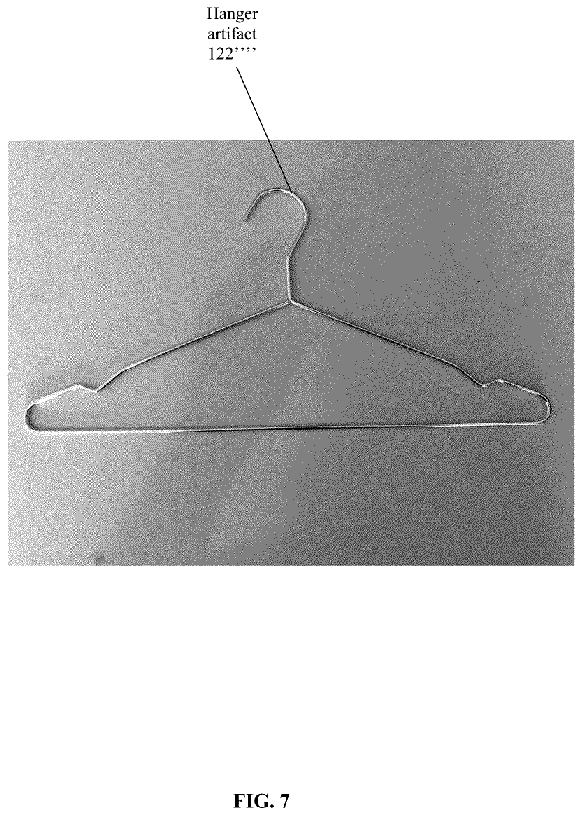

FIG. 7 shows an exemplary hanger 122″″, which additionally may be part of the kit 120 to allow the item 102, specifically a jersey, to hang in the presence of the team for purposes of absorbing the team's energy and mojo. In one embodiment, the hanger is gold in color the could be associated with the player, team, or otherwise.

Another embodiment of the invention includes a method of authenticating an object 102 or item 102, the method comprising affixing a tag 122 to an object 102, the tag 122 having a unique serialized number, and storing the unique serialized number in a database 110, the database 110 being managed by the authenticating authority to ensure validity of an object 102.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

What is claimed is:

1. A kit for authenticating an object, the kit comprising:
a tag including a uniquely serialized number; and
a unique downloadable certificate of authority;
wherein the tag is non-removably attached to the object and comprises cloth or embroidery.

2. The kit of claim 1, wherein the tag additionally comprises an RFID tag.

3. The kit of claim 1, additionally comprising a unique hanger, hanger tag and hang tag.

4. The kit of claim 4, wherein the identifying hanger tag also includes the uniquely serialized number.

5. A method for authenticating an object, the method comprising:
affixing a tag to an object, wherein the tag has a unique serialized number;
storing the unique serialized number in a database, the database managed by an authenticating authority; and
referencing the database to verify the source of the object.

6. A system for authenticating an object and/or a characteristic of the object, the system comprising:
a processor including an authentication module and an interfacing module;
a database;
a memory operatively associated with the processor, the memory having instructions stored thereon that when executed by the processor:
cause the authentication module to generate an object token, the object token including an identifier and associated information related to an object or a characteristic of the object;
cause the authentication module to transmit the object token to the database for storage in the database;
cause the interfacing module to generate a graphical user interface (GUI) for display at a user-computer, the GUI configured to allow a user to enter the identifier; and
cause the interfacing module to transmit the identifier to the authentication module, wherein the authentication module is configured to retrieve the object token associated with the identifier from the database and cause the interfacing module to display the associated information related to the object or the characteristic of the object.

7. The system of claim 6, wherein:
the object is an object set that includes one or more objects;
the object token pertains to all objects within the object set or each object in the object set has an individual object token.

8. The system of claim 6, wherein the instructions when executed by the processor:
cause the interfacing module to generate a certificate of authenticity authenticating the object and/or the characteristic of the object.

9. The system of claim 8, wherein:
the certificate of authenticity is in digital form configured to be stored in memory of the user-computer; and/or
the certificate of authenticity is a prompt to facilitate printing the certificate of authenticity via the user-computer.

10. The system of claim 6, wherein:
the object token is a nonfungible digital identifier, a unique barcode, a unique serial number, a unique hologram, an encrypted data structure, and/or an encoded data structure.

11. The system of claim 6, wherein:
the object is an item; and
the characteristic of the object includes a type of the object, a sports team associated with the object, a sports player associated with the object, a locker associated with the object, an event associated with the object, and/or a place, date, and time associated with the object.

12. The system of claim 6, wherein:
the object includes one or more of sports clothing, sports memorabilia, and sports equipment.

13. The system of claim 12, further comprising:
at least one artifact configured for attachment to the object, the at least one artifact comprising a tag, a hang tag and a hanger tag.

14. An authentication kit, comprising:
an identifier for an object to be authenticated, wherein the identifier is configured to be attached to the object, the identifier being associated with an object token for the object;
wherein:
the object token includes the identifier and associated information related to the object or a characteristic of the object;
the object token is stored in a database;
the identifier is configured to be entered into a user-computer via a graphical user interface (GUI), wherein the object token associated with the identifier is retrieved from the database and the associated information related to the object or the characteristic of the object is displayed via the GUI, wherein the associated information comprises a certificate of authenticity authenticating the object and/or the characteristic of the object

15. The authentication kit of claim 14, wherein:
the object is an object set that includes one or more objects;
the object token pertains to all objects within the object set or each object in the object set has an individual object token.

16. The authentication kit of claim 14, wherein:
the certificate of authenticity is in digital form configured to be stored in memory of the user-computer;
the certificate of authenticity is a prompt to facilitate printing the certificate of authenticity via the user-computer; and/or
the certificate of authenticity is hardcopy included with the authentication kit.

17. The authentication kit of claim 14, wherein:
the object token is a nonfungible digital identifier, a unique barcode, a unique serial number, a unique hologram, an encrypted data structure, and/or an encoded data structure.

18. The authentication kit of claim 14, wherein:
the object is an item; and
the characteristic of the object includes a type of the object, a sports team associated with the object, a sports player associated with the object, a locker associated with the object, an event associated with the object, and/or a place, date, and time associated with the object.

19. The authentication kit of claim 14, wherein:
the object includes one or more of sports clothing, sports memorabilia, and sports equipment.

20. The authentication kit of claim 19, further comprising:
at least one artifact configured for attachment to the object, the at least one artifact comprising a tag, a hang tag and a hanger tag.

21. A method for authenticating an object and/or a characteristic of the object, the method comprising:
generating an object token, the object token including an identifier and associated information related to an object or a characteristic of the object;
storing the object token in a database;
generating a graphical user interface (GUI) for display at a user-computer, the GUI configured to allow a user to enter the identifier;
using user-entered identifier to retrieve the object token associated with the identifier to from the database to display the associated information related to the object or the characteristic of the object via the GUI.

22. The method of claim 21, wherein:
the object is an object set that includes one or more objects;
the object token pertains to all objects within the object set or each object in the object set has an individual object token.

23. The method of claim 21, wherein:
the object includes one or more of sports clothing, sports memorabilia, and sports equipment.
